(19) United States
(12) Patent Application Publication
(10) Pub. No.: US 2005/0027684 A1
(43) Pub. Date: Feb. 3, 2005

(54) Database system and data accessing method thereof

(76) Inventors: Ran-Yih Wang, Taipei City (TW); Hsin-Jun Wu, Taoyuan Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/873,042

(22) Filed: Jun. 21, 2004

(30) Foreign Application Priority Data
Jul. 28, 2003 (TW) 92120566

(51) Int. Cl. G06F 17/30

(52) U.S. Cl. 707/2

(57) ABSTRACT

A method for accessing data records in a database system has the following steps. First, according to a data access request, at least one of data records corresponding to the access request is accessed by reference to a hash table and a record indicator array. When said at least a data record corresponding to the access request is not found by the previous step, at least an index array, at least a link array, and the record indicator array are referred to, in order to access said at least a data record corresponding to the access request.

### BACKGROUND OF THE INVENTION

1. Field of Invention

The present invention relates to a database system and a data accessing method thereof. More particularly, the present invention relates to a database system and a data access method thereof, which employ indexing.

2. Description of Related Art

As electronic technologies advance, the amount of data processed and stored by computers and various electronic devices keeps increasing. Although the accessing speed of a storage device keeps increasing, it's difficult to obtain effectively useful information from even a large amount of data without an effective data accessing method.

In response to the need to access data effectively, database and related techniques have been developed, which improve the efficiency of data retrieval to a certain extent. A database usually has many tables, each of which is composed of many data records. Each data record has many attribute values.

FIG. 1 illustrates the relationship between a table 102 and a storage medium 106. In this example, the table 102 has many data records, each of which has attribute values for the attributes “person's name”, “company”, “age”, and “email address”. For instance, Peter is in the company B&G, is 45 years of age, and has an email address of Peter@BG.com.

In order to store the table 102 in digital equipment, data of the table 102 are converted into corresponding binary sequences 104 by using a standard coding format, such as ASCII or Unicode. These binary sequences 104 are further stored into the storage medium 106, such as a hard disk, a magnetic tape, or a compact disk.

Assuming that data records of the table 102 are stored in the storage medium 106 in the order shown in the table 102, when inquiring as to who is in the company MIDHOST, the attribute value of all data records for the attribute “company” must be examined in the order they are stored, until data records having the attribute value MIDHOST for the attribute “company” are found.

However, this way of searching is very time-consuming for a database with a large amount of data. Therefore, a concept of indexing the data records was introduced to expedite the process of searching. In general, an index is made by arranging the data records in a sequence according to a field or a combination of fields in the data, and storing the resultant sequence as an index file for the purpose of searching for specific information.

As an example, FIGS. 2A and 2B illustrate the making of indexes for the table 102 of FIG. 1 by different sequencing methods.

In FIG. 2A, the attribute value for the attribute “Person's name” is used as the index value, and data records in the table 102 are rearranged into a sequence. The index values, the attribute values for the attribute “Person's name”, of the resultant sequence of the data records and indicators pointing to the data records are stored as an index file.

The content of the index file is an array, each element of which has two sub-elements. The first sub-element is the index value, the attribute value for the attribute “Person's name”, and the second sub-element is the access address in the storage medium of the data record corresponding to the index value, such as a certain offset used for addressing in a certain sector of a certain disk.

After an index file is created, when searching for a data record having a specific index value is desired, the specific index value can be compared with the index values in the index file under one of various searching methods to find the address of the location at which the data record having the specific index value is stored.

Although in FIG. 2A only one attribute is used for indexing, indexing can be achieved by using at least two attributes or any combination of attributes. For example, in FIG. 2B, the attributes “Company” and “Age” are used for indexing.

Even if indexing increases the speed of searching the data indeed, it requires space, and when the data are changed the index must be made again, which indirectly affects the overall efficiency of the database. Therefore, in real practice, whether or not a flexible and efficient framework of indexing can be established will significantly affect performance in accessing data.

In addition, because of the diversity of electronic applications, the distinction between an electronic device and a computer has become increasingly blurred. Although the database technology was initially designed for computers, at present many special electronic devices, such as switches, gateways, and routers, all use databases of different sizes to provide more powerful functions. These electronic devices are often subject to design restrictions due to the characteristics of their hardware architecture.

Therefore, how to properly take advantage of schemes, such as indexing, to design a flexible data accessing system and method with efficient data accessing performance for computers and various electronic devices is a very important task.

### SUMMARY OF THE INVENTION

Therefore, an objective of the present invention is to provide a data accessing method to access efficiently data records stored in a database.

Another objective of the present invention is to provide a database system, which provides the users with an efficient data accessing system.

Still another objective of the present invention is to provide a function library, for integration by users into a database system for efficiently accessing data.

According to an embodiment of the data accessing method of the invention, the following steps are performed. First, according to a data access request, at least one of data records corresponding to the access request is accessed by reference to a hash table and a record indicator array. When the data record corresponding to the access request is not found by the previous step, at least an index array, at least a link array, and the record indicator array are referred to, in order to access the data record corresponding to the access request.

The record indicator array comprises record indicators, each of which points to one of the data records, respectively. Said at least an index array and at least a link array are with respect to a distinct sequencing method. The data records are divided into subsets according to the sequencing method. The link array points out the next record indicator with respect to each record indicator in the record indicator array according to the sequencing method, and the index array points out an initial record indicator, an end record indicator, and the number of data records for each of the subsets. The initial record indicator is the record indicator of the first data record of each of the subsets, the end record indicator is the record indicator of the last data record of each of the subsets, and the number is the number of data records of each of the subsets.

In another embodiment of the present invention, the data accessing method described above can be carried out as a database system, or as a function library.

Accordingly, the invention possesses the following advantages. First, with the hash table, the speed at which data are accessed or searched for is increased. Second, when the data searched for is not found through the hash table, the data range to be searched is rapidly and significantly reduced by the use of the index array, and then the link array is sequentially searched. Third, for different indexes and sequencing methods used, different link arrays and index arrays can be used, while the record indicator array need not change. Fourth, the data accessing method is effective for considerations of efficiency and space. The users can adjust the index array and the size of the hash table according to need, so as to achieve various balancing requirements.

### BRIEF DESCRIPTION OF THE DRAWINGS

These and other features, aspects, and advantages of the present invention will become better understood with regard to the following description, appended claims, and accompanying drawings where:

FIG. 1 illustrates the relationship between a database and a storage medium;

FIG. 2A illustrates the concept of indexing;

FIG. 2B illustrates the concept of indexing;

FIG. 3 illustrates a structure illustrating an embodiment of the invention;

FIG. 4 illustrates interrelations between data necessarily used in the embodiment of the invention;

FIG. 5A illustrates the connection between data;

FIG. 5B illustrates the connection between data;

FIG. 6 is a flow chart illustrating an embodiment of the invention;

FIG. 7A illustrates a case of the balancing procedures;

FIG. 7B illustrates another case of the balancing procedures; and

FIG. 7C illustrates still another case of the balancing procedures.

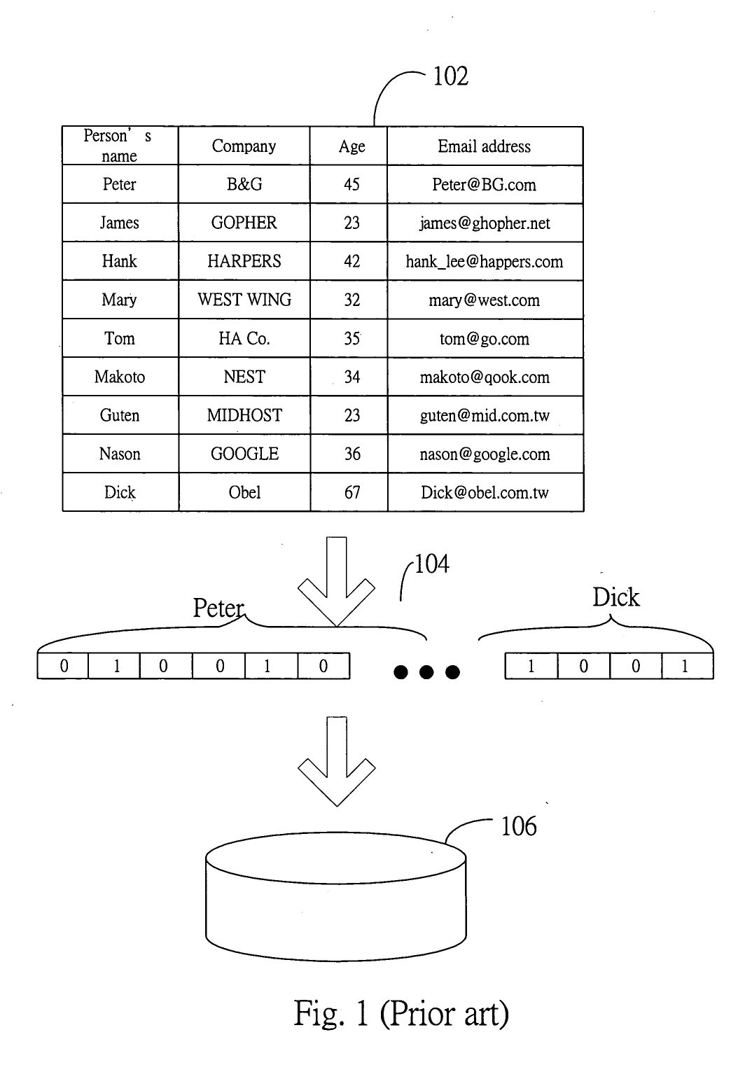

### DESCRIPTION OF THE PREFERRED EMBODIMENTS

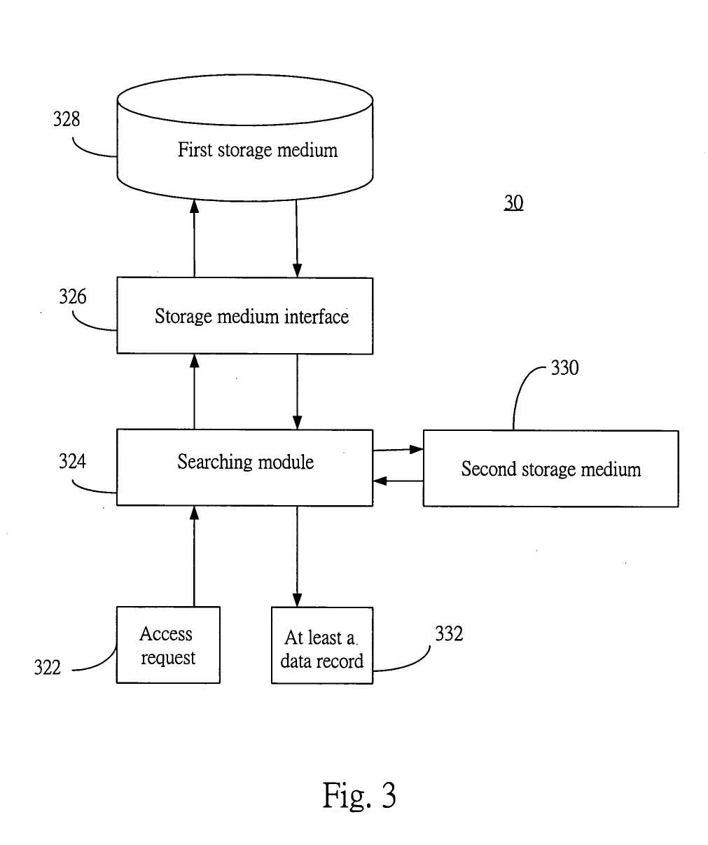

FIG. 3 illustrates a database system 30 according to a preferred embodiment of the invention. The database system 30 has at least a first storage medium 328, a storage medium interface 326, a second storage medium 330, and a searching module 324.

The first storage medium 328, such as a hard disk, a compact disk, a magnetic tape, a flash memory, or a distributed storage system, is used to store data records of the database. When the storage medium interface 326 for the first storage medium 328 receives a record indicator, such as a relative address in a certain sector, the storage medium interface 326 reads and retrieves from the first storage medium 328 the data record 332, to which the record indicator points. In other words, the storage medium interface can be software such as a driver program, hardware such as a controller, or any combination of software and a hardware that is able to receive the record indicator and then retrieve the corresponding data record.

The second storage medium 330, such as a memory or a hard disk, is used to store a hash table, a record indicator array, at least an index array, and at least a link array. It should be understood that the first storage medium 328 and the second storage medium 330 can be separate parts of the same hardware in their practical realization. For example, they can be two different portions in a hard disk, respectively.

The searching module 324 receives an access request 322, such as a search instruction in SQL (Structured Query Language) standard query language. The searching module 324 first reads, according to the content of the access request 322, the hash table and the record indicator array stored in the second storage medium 330, to find out if any data record satisfying the access request 322 is present. If at least a data record satisfying the access request 322 is found, the storage medium interface 326 is used, through the record indicator stored in the record indicator array, so as to access the corresponding data record 332 stored in the first storage medium 328.

On the contrary, if no data record satisfying the access request can be found through the hash table and the record indicator array, the index array, the link array, and the record indicator array stored in the second storage medium 330 are further used for accessing at least a data record satisfying the access request.

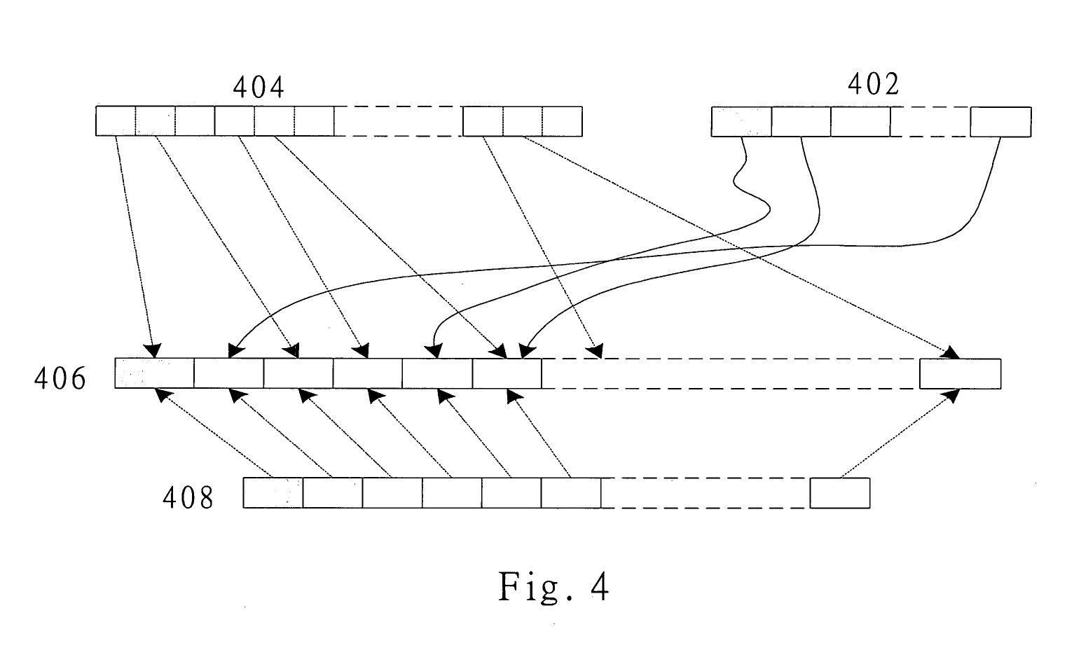

FIG. 4 illustrates interrelations between the hash table 402, the index array 404, the record indicator array 406, and the link array 408 stored in the second storage medium 330.

The record indicator array 406 stores a series of record indicators. By using these record indicators, the storage medium interface 326 can be used for accessing the data records stored in the first storage medium 328 corresponding to these record indicators.

The hash table 402 is also in the form of an array, each element of which stores a value pointing to an element of the record indicator array 406. Also, the hash table 402 itself is established from calculations using hash functions according to the access request 322. For instance, when the access request 322 is assumed to be a combination of the three attributes “person's name”/“company”/“age”, the hash function can be calculation of the remainder after the sum of the three numerical values of the three attributes is divided by the length of the hash table 402. By way of illustration, the sum of the numerical values (65+66+23) corresponding to “A”/“B”/“23” is calculated, then divided by the length 1024 of the hash table 402, and the remainder of which is 154, which is the hash function value.

The hash function value calculated is an index in the array of the hash table 402. For the above example, the access request 322 of “A”/“B”/“23” corresponds to the number 154 element of the hash table 402, the value of which points to a particular element of the record indicator array 406, which further points to a particular data record stored in the first storage medium 328.

Therefore, using the hash table 402 in ideal circumstances can locate the data record satisfying the access request in a shorter period of time.

If the element satisfying the access request 322 cannot be located in the hash table 402 at the first instance through using the hash function, it will be looked for backwards at a predetermined distance according to a predefined rule of the hash function. If the element is still not located, it will be looked for backwards again at the predetermined distance. The number of times for looking for the element backwards is the number of layers of the hash function.

For example, a hash function is as follows

$$[ HashValue [ i ] = {\sum }_{j = 0 , 4 , 5 , …}^{j < key\_length} ( Key [ i + j ] ) \vert \begin{matrix}i < 4 \\ i = 0\end{matrix}$$

HashIndex=HashValue mod total_hash_nbr
HashIndexDepthi=(HashIndex+(17*i))|Collision

HashValue[i] is the hash function value, Key is the index value or attribute value, and the index HashIndex in the hash table is the remainder after HashValue is divided by the size total_hash_nbr of the hash table. If the corresponding element cannot be located in the hash table at the first instance, it is looked for backwards at a distance of 17. In this example, the maximum number of times for looking for the element backwards is 4, that is, there are 4 layers in the hash function. If the element cannot be located during the 4 times, the hash table ceases to be used to conduct the search.

Accordingly, the size of the hash table, the hash function, and the number of layers of the hash function all affect the chance of locating the needed data in the hash table. Although a large hash table and a complex hash function seem to be more ideal, it's not appropriate to perform all the searching work through the hash table, due to the considerations of cost and operation complexities.

When the searching module 324 cannot locate the needed data record through the hash table 402, the searching module 324 will start to use the index array 404, the link array 408, and the record indicator array 406 to continue searching for the data.

The index array 404 and the link array 408 are made according to a particular sequencing method. Also, the link array 408 points out the next record indicator with respect to each record indicator in the record indicator array 406 according to the particular sequencing method.

The index array 404 divides data records into subsets according to the corresponding sequencing method, and points out ranges of record indicators covered in the subsets. In addition, the index array 404 also points out the number of data records in each subset.

For example, when the attribute “person's name” is used for indexing, and sequencing is performed, all data records can be divided into four subsets. All data records in each of the four subsets have an initial letter in a respective one of the letter ranges of A-C, D-M, N-P, and Q-Z. In this instance, each element of the index array 404 has three values, which are an initial value, an end value, and the number of data records in a subset. The first two values are used to define the range of a subset, and the third value gives the quantity of data records in a subset.

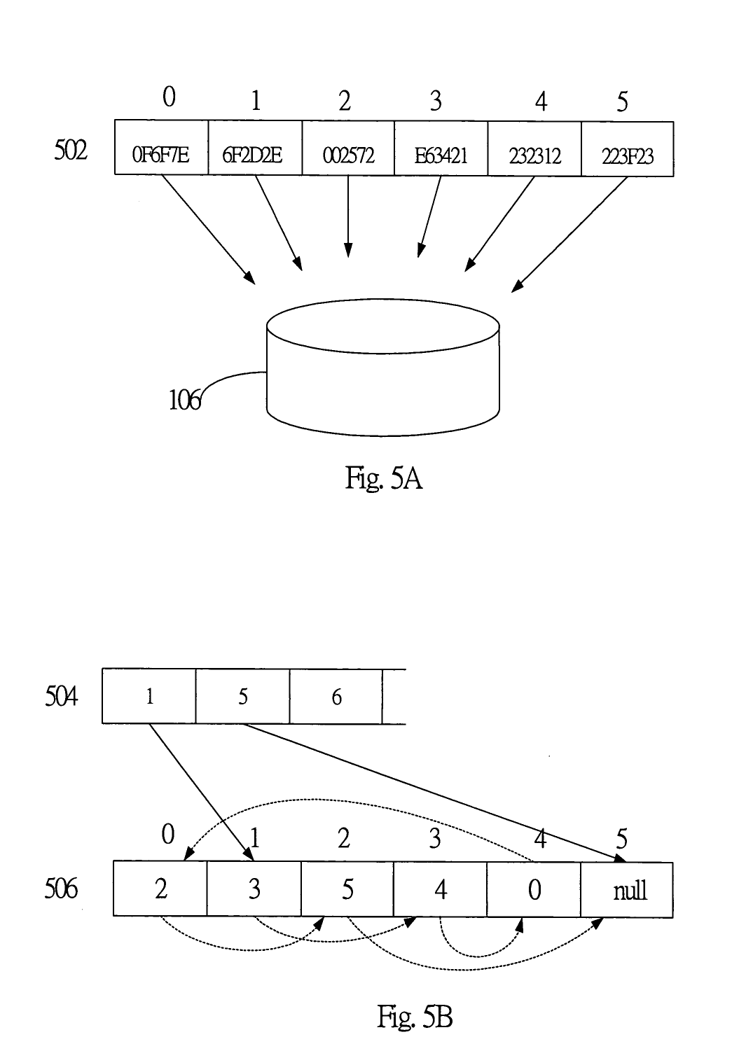

FIGS. 5A and 5B illustrate the method for the practical realization of the link array 408 and the index array 404. In FIG. 5A, an example 502 of the record indicator array 406 has six elements, numbered from 0 to 5, and the contents of the six elements point to different data records stored in the storage medium 106, respectively.

FIG. 5B illustrates an example 504 of the index array 404. In this figure, an array element of the index array 404 is shown consisting of three parts “1”, “5”, and “6”. “1” is the initial value of a subset indicated by the array element, “5” is the end value of the subset, and “6” is the number of data records in the subset.

In addition, an example 506 of the link array 408 corresponds one-to-one with the example 502 of the record indicator array 406, and each element of the example 506 of the link array 408 points out the location of the next record indicator according to the sequencing method.

For instance, according to the example 506 of the link array 408 and the example 504 of the index array 404, the subset is known to begin with the element numbered 1, and the number sequence of elements of the example 502 of the record indicator array 406 resulting from the sequencing method is “1”, “3”, “4”, “0”, “2”, “5”. This can be seen from the fact that the element numbered 1 of the example 506 of the link array 408 corresponding to the element numbered 1 of the example 502 of the record indicator array 406 refers to the element numbered 3, the element numbered 3 further refers to the element numbered 4, and the other references between elements in the number sequence are in the same way, as shown in FIGS. 5A and 5B.

After the index array 404 is established, a method, such as a binary search, can be employed to find the subset having the data record that contains the index value to be searched for. Record indicators with respect to the subset are then searched, starting at the initial record indicator, with the aid of the link array 408, to find the data record satisfying the requirement.

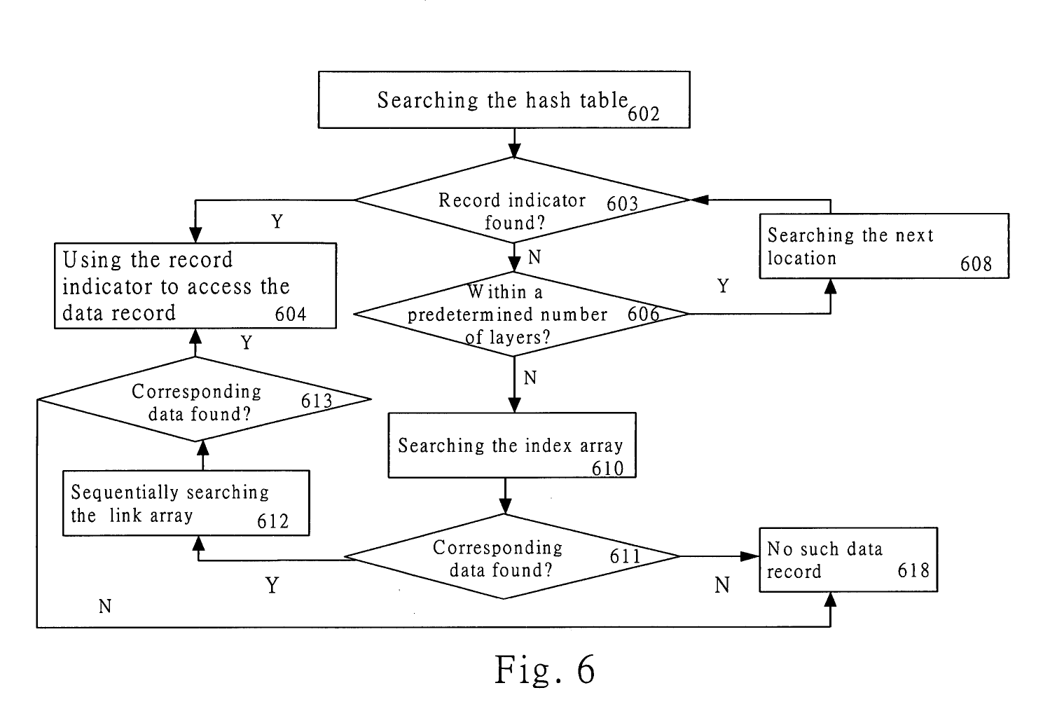

FIG. 6 is a flow chart illustrating how to use the hash table 402, the index array 404, the record indicator array 406, and the link array 408 to conduct data accessing and searching.

First, the hash table 402 is searched according to the data access request (step 602). Then it is judged if the record indicator corresponding to the data record satisfying the access request can be found in the hash table 402 (step 603). If the record indicator is directly found, it is used to access the corresponding data record (step 604). If the record indicator is not found in the hash table 402, that is, a collision happens, it is judged if the record indicator is within a predetermined number of layers (step 606), such as looking for the record indicator backwards at a predetermined distance for at most 3 times as in the example described above. If the record indicator is within the predetermined number of layers, the next location in the hash table 402 is searched (step 608). Similarly, if at this time the record indicator satisfying the access request is found, it is used to access the corresponding data record (step 604). Otherwise, a binary search is performed on the index array to find the corresponding data (step 610). Then it is judged if the data satisfying the access request can be found (step 611). If the corresponding data cannot be found through the binary search, the data record is not in the database (step 618). Otherwise, the link array 408 is sequentially searched (step 612). Then it is judged if the data satisfying the access request can be found (step 613). If the corresponding record indicator is not found through the sequential search, the data record is not in the database (step 618). Otherwise, the record indicator array 406 is likewise used to access the data record satisfying the access request (step 604).

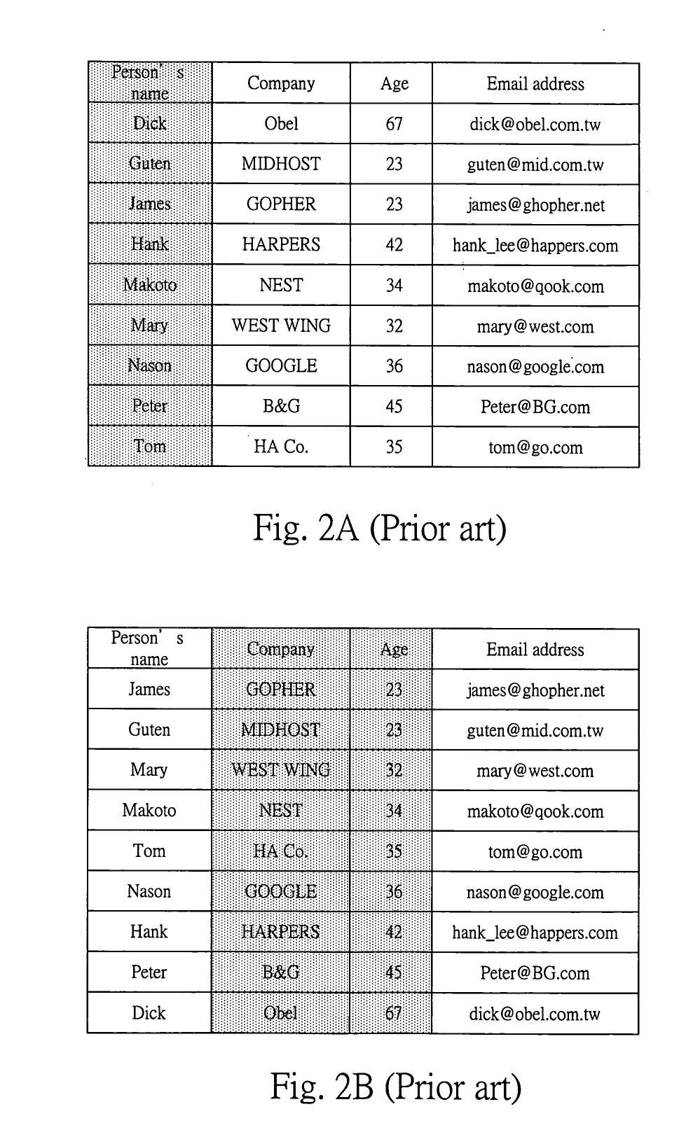

In addition, in the description above, only one link array 408 and one index array 404 are mentioned and used. However, depending on different indexes and sequencing methods used, more than one link array 408 and more than one index array 404 can be used. For example, when two different indexes and sequencing methods are used, such as the two instances shown in FIG. 2A and FIG. 2B, only one more link array 408 and one more index array are needed, while the record indicator array 406 and the hash table 402 need not change.

Moreover, when the data records in the database are changed as the data records are accessed, for example, 100 more data records are added, only the link array and the index array need to be adjusted, and the hash table 402 remains unchanged.

Additionally, the use of the index array 404 described above can significantly reduce the data range to be searched, and this effect is closely associated with the size of the subset represented by each element of the index array 404. In a better case, these subsets all have a similar number of elements, which can enhance spatial and temporal optimization. The following pseudocode describes balancing procedures that make the difference in the number of data records of a subset between the subsets represented by the index array less than a predetermined value.

1. if ∃k, index_element_nbrₖ>N₂, then

1.1 while ∀i, | (index_element_nbrᵢ-average_element_nbr)>N₁

1.1.1 if index_element_nbrᵢ < average_element_nbr,

and(index_element_nbrᵢ+index_element_nbrᵢ₊₁)
<=average_element_nbr, then indexᵢ₊₁ is merged to indexᵢ.

1.1.2 if index_element_nbrᵢ<average_element_nbr, and

(index_element_nbrᵢ+index_element_nbrᵢ₊₁)> average_element_nbr,
then
(average_element_nbr-index_element_nbrᵢ) elements are moved
from indexᵢ₊₁ to indexᵢ.

1.1.3 if index_element_nbrᵢ>average_element_nbr, then

(index_element_nbrᵢ-average_element_nbr) elements are split to
indexᵢ₊₁.

In these balancing procedures, searching is first done to see if the number index_element_nbrₖ of data records of a subset represented by an element, if any, numbered k in the index array 404 is larger than a predetermined value N₂. If that is the case, procedures (including 1.1.1, 1.1.2, 1.1.3) in the loop 1.1 are performed until the difference between the number index_element_nbrᵢ of data records of a subset represented by each element in the index array 404 and the average number average_element_nbr of data records of a subset represented by each element in the index array 404 is smaller than N₁.

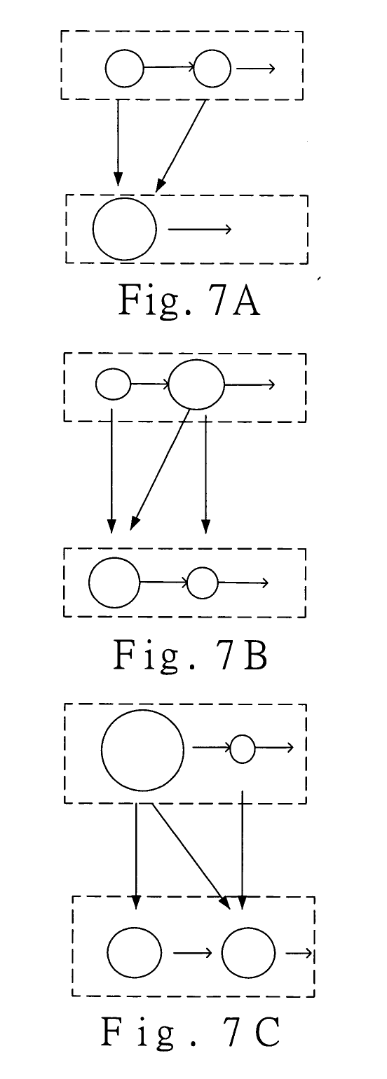

In the loop 1.1, three different balancing procedures are used depending on three different situations. FIGS. 7A, 7B, and 7C illustrate the three different situations, wherein the size of each circle represents the number of data records of a subset corresponding to the circle.

In the procedure 1.1.1, if the number index_element_nbrᵢ of data records of the subset represented by the element number i in the index array 404 is smaller than the average number average_element_nbr of data records of a subset represented by each element in the index array 404, and the sum of the numbers of data records of the subsets represented by the elements number i and number i+1 in the index array 404 is smaller than or equal to the average number average_element_nbr of data records of a subset represented by each element in the index array 404, then the element number i+1 is merged into the element i of the index array 404, as shown in FIG. 7A.

In the procedure 1.1.2, if the number of data records of the subset represented by the element number i in the index array 404 is smaller than the average number average_element_nbr of data records of a subset represented by each element in the index array 404, and the sum of the numbers of data records of the subsets represented by the elements number i and number i+1 in the index array 404 is larger than the average number average_element_nbr of data records of a subset represented by each element in the index array 404, then a number (average_element_nbr-index_element_nbrᵢ) of data records of the subset represented by the element number i+1 in the index array 404 are moved to the subset represented by the element number i, as shown in FIG. 7B.

In the procedure 1.1.3, if the number of data records of the subset represented by the element number i in the index array 404 is larger than the average number average_element_nbr of data records of a subset represented by each element in the index array 404, then a number (index_element_nbrᵢ-average_element_nbr) of data records of the subset represented by the element number i in the index array 404 are moved to the subset represented by the element number i+1, as shown in FIG. 7C.

By using these balancing procedures, the difference in the number of data records of a subset between the subsets represented by the index array is made less than a predetermined value. In other words, the overall speed at which data records are accessed is improved.

In addition to being carried out as a database system, the data accessing method described above can also be carried out as a function library. Users can integrate the function library into a database system, such as SQL server or ORACLE.

An embodiment of the function library includes an index creation function, a data access function, and an index maintenance function. The index creation function receives a plurality of data records and at least a sequencing method as parameters, and produces the record indicator array, the hash table, at least an index array, and at least a link array, which are described above, according to the plurality of data records and said at least a sequencing method. The data access function receives an access request as a parameter and accesses, according to the access request, at least one of the plurality of data records corresponding to the access request by reference to the hash table and the record indicator array. When said at least one of the plurality of data records corresponding to the access request is not found by reference to the hash table and the record indicator array, the data access function refers to said at least an index array, said at least a link array, and the record indicator array to access said at least one of the plurality of data records corresponding to the access request. In addition, when said at least an index array is adjusted, the index maintenance function performs a balancing procedure to balance the elements of said at least an index array.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A data accessing method for accessing a plurality of data records in response to an access request, said method comprising:
according to said access request, accessing at least one of the plurality of data records corresponding to said access request by reference to a hash table and a record indicator array; and
when said at least one of the plurality of data records corresponding to said access request is not found by reference to said hash table and said record indicator array, referring to at least an index array, at least a link array, and said record indicator array, to access said at least one of the plurality of data records corresponding to said access request.

2. The method of claim 1, wherein said record indicator array comprises record indicators, each pointing to one of the plurality of data records, respectively.

3. The method of claim 1, wherein said at least an index array and at least a link array are with respect to a distinct sequencing method, and the plurality of data records are divided into subsets according to said sequencing method.

4. The method of claim 3, wherein said link array points out a next record indicator with respect to each record indicator in said record indicator array according to said sequencing method, and said index array points out an initial record indicator, an end record indicator, and a number of data records for each of the subsets, and wherein said initial record indicator is a record indicator of a first data record of each of the subsets, said end record indicator is a record indicator of a last data record of each of the subsets, and said number is the number of data records of each of the subsets.

5. The method of claim 4, wherein the step of referring to said at least an index array, said at least a link array, and said record indicator array, to access said at least one of the plurality of data records comprises:
searching said at least an index array by using binary search for an initial record indicator of a subset corresponding to said access request; and
using said at least a link array to sequentially search, starting at said initial record indicator, for said at least one of the plurality of data records corresponding to said access request.

6. The method of claim 3, wherein said at least an index array and at least a link array change with said distinct sequencing method.

7. The method of claim 3, wherein said sequencing method is defined according to said access request.

8. The method of claim 3, wherein said sequencing method is a rule for making indexes.

9. The method of claim 1, wherein said hash table contains elements placed at predetermined distance intervals, and each of said elements has an identical hash function value.

10. The method of claim 3, wherein said at least an index array and at least a link array are adjusted in response to a change of said plurality of data records.

11. The method of claim 10, wherein when said at least an index array is adjusted, a balancing procedure is performed to make a difference in a number of data records of a subset between said subsets less than a predetermined value.

12. A database system, said database comprising:
a first storage medium used for storing a plurality of data records;
a storage medium interface corresponding to said first storage medium, for receiving a record indicator and returning one of the plurality of data records corresponding to the record indicator;
a second storage medium used for storing a hash table, a record indicator array, at least an index array, and at least a link array; and
a searching module, said searching module receiving an access request and, according to said access request, accessing, through said storage medium interface, at least one of the plurality of data records corresponding to said access request by reference to said hash table and said record indicator array stored in said second storage medium; and
when said at least one of the plurality of data records corresponding to said access request is not found by reference to said hash table and said record indicator array, said searching module refers to said at least an index array, said at least a link array, and said record indicator array stored in said second storage medium, to access said at least one of the plurality of data records corresponding to said access request.

13. The database system of claim 12, wherein said record indicator array comprises record indicators, each pointing to one of the plurality of data records, respectively.

14. The database system of claim 12, wherein said at least an index array and at least a link array are with respect to a distinct sequencing method, and the plurality of data records are divided into subsets according to said sequencing method.

15. The database system of claim 14, wherein said link array points out a next record indicator with respect to each record indicator in said record indicator array according to said sequencing method, and said index array points out an initial record indicator, an end record indicator, and a number of data records for each of the subsets, and wherein said initial record indicator is a record indicator of a first data record of each of the subsets, said end record indicator is a record indicator of a last data record of each of the subsets, and said number is the number of data records of each of the subsets.

16. The database system of claim 15, wherein said searching module refers to said at least an index array, said at least a link array, and said record indicator array by searching said at least an index array using binary search for the initial record indicator of the subset corresponding to said access request, and using said at least a link array to search sequentially, starting at said initial record indicator, for said at least one of the plurality of data records corresponding to said access request.

17. The database system of claim 14, wherein said at least an index array and at least a link array change with said distinct sequencing method.

18. The database system of claim 14, wherein said searching module determines said sequencing method according to said access request, and uses said at least an index array and at least a link array with respect to said sequencing method.

19. The database system of claim 14, wherein said sequencing method is a rule for making indexes.

20. The database system of claim 12, wherein said hash table contains elements placed at predetermined distance intervals, and each of said elements has an identical hash function value.

21. The database system of claim 14, wherein said at least an index array and at least a link array are adjusted in response to a change of said plurality of data records.

22. The database system of claim 21, wherein when said at least an index array is adjusted, a balancing procedure is performed to make a difference in the number of data records of a subset between said subsets less than a predetermined value.

23. The database system of claim 12, wherein said first storage medium is a hard disk and said second storage medium is a memory.

24. A function library, comprising:
an index creation function, receiving a plurality of data records and at least a sequencing method as parameters, said index creation function producing a record indicator array, a hash table, at least an index array, and at least a link array according to the plurality of data records and said at least a sequencing method; and
a data access function, receiving an access request as a parameter and accessing, according to said access request, at least one of the plurality of data records corresponding to said access request by reference to said hash table and said record indicator array, and when said at least one of the plurality of data records corresponding to said access request is not found by reference to said hash table and said record indicator array, said data access function refers to said at least an index array, said at least a link array, and said record indicator array to access said at least one of the plurality of data records corresponding to said access request.

25. The function library of claim 24, wherein said record indicator array comprises record indicators, each pointing to one of the plurality of data records, respectively, wherein said at least an index array and at least a link array are with respect to a distinct sequencing method, and the plurality of data records are divided into subsets according to said sequencing method, and wherein said link array points out the next record indicator with respect to each record indicator in said record indicator array according to said sequencing method, said index array points out an initial record indicator, an end record indicator, and a number of data records for each of the subsets, said initial record indicator is a record indicator of the first data record of each of the subsets, said end record indicator is a record indicator of the last data record of each of the subsets, and said number is the number of data records of each of the subsets.

26. The function library of claim 25, further comprising an index maintenance function, wherein when said at least an index array is adjusted, said index maintenance function performs a balancing procedure to make a difference in the number of data records of a subset between said subsets less than a predetermined value.
